(19) United States
(12) Patent Application Publication
(10) Pub. No.: US 2004/0110422 A1
(43) Pub. Date: Jun. 10, 2004

(54) Modular jack

(75) Inventors: Hiroshi Sasai, Tokyo (JP); Mutsumi Kinoshita, Tokyo (JP); Mitsutaka Yasuda, Tokyo (JP); Tadashi Fukuda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 10/727,606

(22) Filed: Dec. 5, 2003

(30) Foreign Application Priority Data
Dec. 6, 2002 (JP) 2002-354461

(51) Int. Cl. H01R 13/66

(52) U.S. Cl. 439/620

(57) ABSTRACT

A first terminal block 3 having first terminals 2 to be in contact with terminals of a plug is incorporated in a housing 1. The first terminals 2 are exposed to an internal space portion 1e of the housing 1, while the rear ends of the first terminals 2 project at the rear of the block 3. A second terminal block 5 has second terminals 4 to be connected to a motherboard the modular jack should be attached to. Electronic parts 7a and 7b are mounted on an internal board 6. The internal board 6 includes through-hole-like terminals 6a and 6b or notch-like terminals to which the first and second terminals 2 and 4 should be soldered. Winding terminals 8 of winding parts are inserted and soldered to through holes 6c and 6d of the internal board 6.

### BACKGROUND OF THE INVENTION

The present invention relates to a modular jack including electronic parts therein, and particularly relates to an RJ-45 type modular jack to be used for connecting a LAN cable.

For example, a related-art modular jack is disclosed in U.S. Pat. No. 6,319,064. This modular jack is arranged so that a terminal block is incorporated in a housing having an internal space to which a plug should be inserted, and a block that receives electronic parts is incorporated in the terminal block.

The terminal block includes not only first terminals to be brought into contact with terminals of a plug but also second terminals to be connected to a motherboard. The block has a box-like shape that is incorporated on the back surface side of the housing, and that is opened on the housing side (front) for receiving the electronic parts. The upper surface of the block is formed as a connection portion to the first terminals, while the lower surface of the block is formed as a connection portion to the second terminals. The block receiving the electronic parts is mounted on a bottom plate portion of the terminal block extending at the rear thereof, and incorporated in the bottom plate portion. Then, winding terminals of the electronic parts are fitted into a groove provided at the upper opening edge of the block and a groove provided at the lower opening edge of the block respectively. The winding terminals fitted into the grooves are soldered with the rear end portions of the first terminals, and the second terminals, in the upper and lower surface portions of the block receiving the electronic parts, respectively.

In addition, another related-art modular jack having a different structure from that of Patent Document 1 is also known. In this structure, in order to make assembling easier, not only electronic parts but also a modular jack are mounted on one board, and the board with the modular jack is covered with upper and lower covers (see Japanese Patent Publication No. Hei-5-3415/(1993)).

In the modular jack disclosed in U.S. Pat. No. 6,319,064, there is a problem that the soldering work is difficult particularly due to the structure in which the block receiving the electronic parts is mounted on and soldered with the second terminals to be connected to a motherboard. Particularly, when the electronic parts include a winding part such as a transformer or a common mode choke coil as described above, there is a problem that soldering becomes more difficult because the soldering has to be performed while the second terminals and the winding terminals are aligned with each other.

On the other hand, in the structure disclosed in Japanese Patent Publication Hei-5-3415, there is a problem that the total structure including the modular jack becomes large in size.

### SUMMARY OF THE INVENTION

In consideration of the foregoing problems belonging to the related art, it is an object of the invention to provide a modular jack which is assembled easily and which can be arranged in a small size.

According to the invention, there is provided a modular jack including: a housing having an internal space into which a plug should be inserted; a first terminal block incorporated in the housing and integrally provided with first terminals to be in contact with terminals of the plug, so that front portions of the first terminals are exposed to the internal space, while rear ends of the first terminals project at the rear of the first terminal block; a second terminal block having second terminals to be connected with a mother board the modular jack should be attached to; and an internal board mounted with electronic parts and including through-hole-like or notch-like terminals to which the first and second terminals should be soldered.

When the electronic parts are mounted thus on the internal board, and the first and second terminals are soldered with the internal board, assembling becomes easy. In addition, the modular jack is not mounted on the board mounted with the electronic parts but arranged so that the terminal block is incorporated in the housing, and the internal board is coupled with the terminal block. Thus, the modular jack can be arranged in a small size.

The modular jack according to the invention is suitably applicable to the case where the electronic parts include at least one of a common mode choke coil and a transformer.

The modular jack according to the invention is suitably applicable to the case where the electronic parts include at least one of a resistor, a capacitor and a light emitting diode.

When the electronic parts include a winding part in the modular jack according to the invention, it is preferable that the internal board has through holes to which terminals of the winding parts are inserted and soldered. When the winding terminals are inserted into the through holes and soldered therewith in advance independently of the terminals of the modular jack, the work of soldering the winding terminals becomes easy.

The modular jack according to the invention can adopt a structure in which the second terminal block is incorporated on the back surface side of the housing, while the internal board is provided between the first terminal block and the second terminal block.

Such a structure is advantageous in view of the number of parts because the second terminal block serves as a cover for covering the included parts.

As another structure of a combination of constituent parts of a modular jack according to the invention, it is possible to adopt a structure in which: the first terminal block and the second terminal block are received and incorporated in the housing so that connection portions of the first and second terminals to the internal board project rearward; the connection portions of the first and second terminals are inserted and soldered to the through-hole-like or notch-like terminals of the internal board; and a cover covering the internal board therewith is provided on the back surface side of the housing.

With such a structure, the work of soldering between the internal board and the first terminals and between the second terminals and the internal board can be carried out at one time. Thus, the assembling work can be performed efficiently.

In the modular jack according to the invention, it is preferable that: a plurality of through-hole-like or notch-like terminals to which the first terminals are inserted and soldered are arrayed in an upper portion of the internal board; and a plurality of through-hole-like or notch-like terminals to which the second terminals are inserted and soldered are arrayed in a lower portion of the internal board.

### BRIEF DESCRIPTION OF THE DRAWINGS

FIGS. 1A-1E show an embodiment of a modular jack according to the invention, FIG. 1A being a front view, FIG. 1B being a plan view, FIG. 1C being a back view, FIG. 1D being a side view, FIG. 1E being a bottom view.

FIGS. 2A-2F show a housing constituting the modular jack shown in FIGS. 1A-1E, FIG. 2A being a front view, FIG. 2B being a plan view, FIG. 2C being a back view, FIG. 2D being a side view, FIG. 2E being a bottom view, FIG. 2F being a sectional view taken on line Y-Y in FIG. 2A.

FIGS. 3A-3C show a first terminal block constituting the modular jack shown in FIGS. 1A-1E, FIG. 3A being a plan view, FIG. 3B being a side view, FIG. 3C being a bottom view.

FIGS. 4A-4F show a second terminal block constituting the modular jack shown in FIGS. 1A-1E, FIG. 4A being a front view, FIG. 4B being a plan view, FIG. 4C being a back view, FIG. 4D being a side view, FIG. 4E being a bottom view, FIG. 4F being a sectional view showing the structure in which a second terminal is attached.

FIGS. 5A-5B show an internal board constituting the modular jack shown in FIGS. 1A-1E, FIG. 5A being a front view, FIG. 5B being a back view.

FIGS. 6A-6B show the modular jack shown in FIGS. 1A-1E, FIG. 6A being a sectional view, FIG. 6B being a side view showing the state where the modular jack is being assembled.

FIGS. 7A-7F show constituent parts in another embodiment of the modular jack according to the invention, FIG. 7A being a side view of a housing, FIG. 7B being a side view of a first terminal block, FIG. 7C being a side view of a second terminal block, FIG. 7D being a side view of an internal board mounted with electronic parts, FIG. 7E being a front view of FIG. 7D, FIG. 7F being a side view of a cover.

FIG. 8 is a sectional view of the modular jack shown in FIGS. 7A-7E.

FIG. 9 is a equivalent circuit diagram of an example of the internal circuit board of the present invention.

### DETAILED DESCRIPTION OF THE PREFERRED EMBODIMENTS

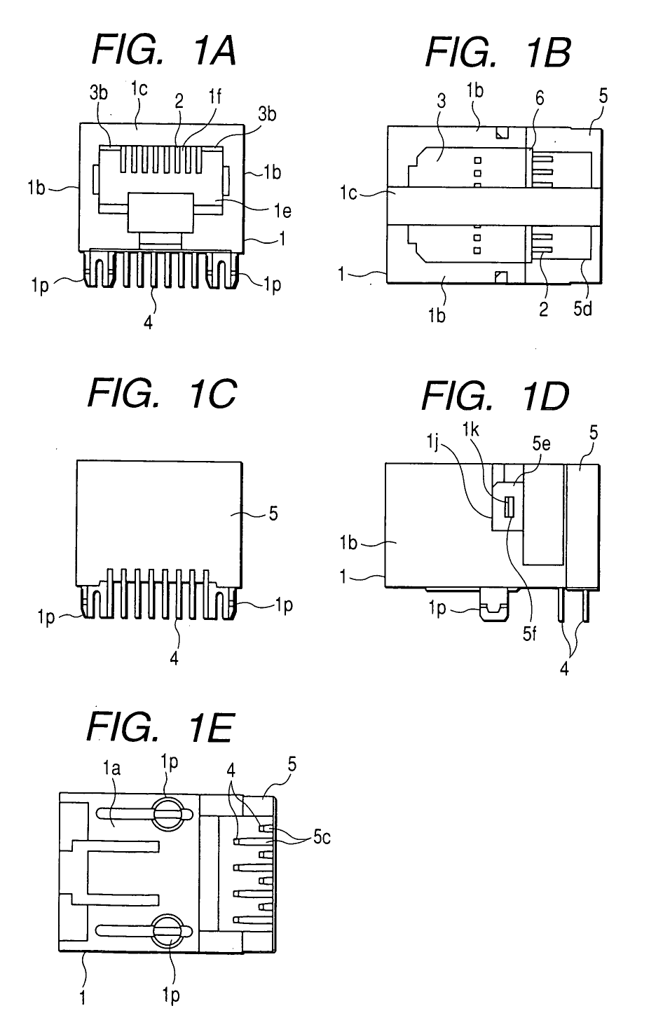

FIGS. 1A-1E show an embodiment of a modular jack according to the invention. FIG. 1A is a front view; FIG. 1B, a plan view; FIG. 1C, aback view; FIG. 1D, a side view; and FIG. 1E, a bottom view. This modular jack is constituted by a housing 1, a first terminal block 3 having first terminals 2, a second terminal block 5 having second terminals 4, and an internal board 6 to be mounted with electronic parts.

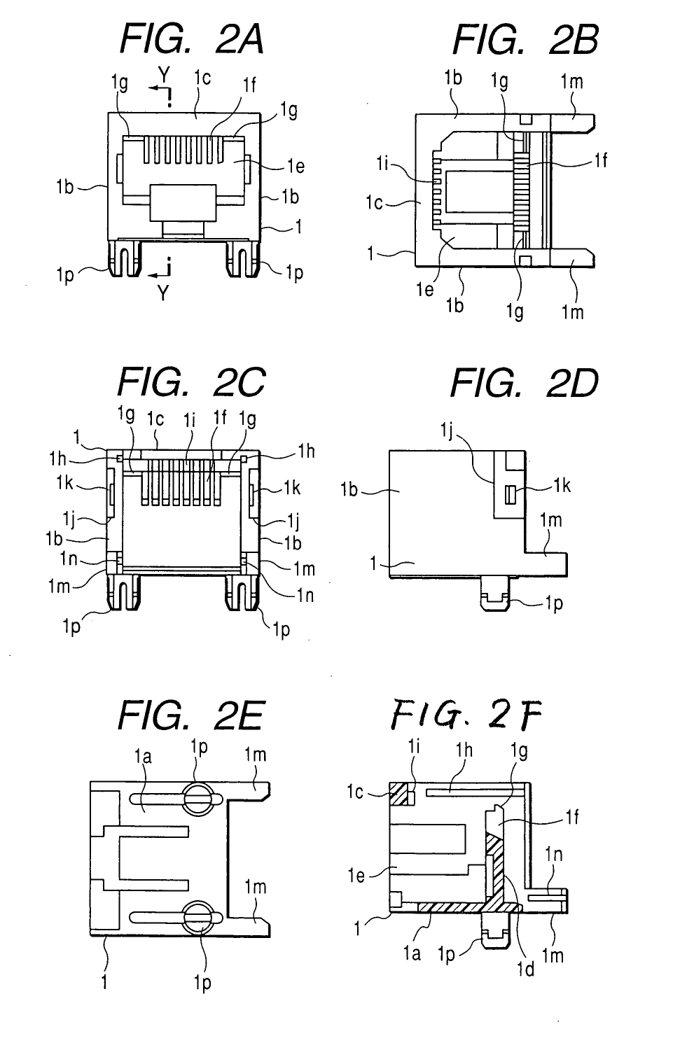

FIGS. 2A-2F show the housing 1. FIG. 2A is a front view; FIG. 2B, a plan view; FIG. 2C, a back view; FIG. 2D, a side view; FIG. 2E, a bottom view; and FIG. 2F, a sectional view taken on line Y-Y in FIG. 2A. As illustrated in these views, the housing 1 has a bottom plate portion 1a, left and right side plate portions 1b, and a bridging portion 1c for linking the upper front portions of the left and right side plate portions 1b and 1b with each other. In addition, the housing 1 has an intermediate wall 1d rising upward from the bottom plate portion 1a. Thus, an internal space portion 1e into which a not-shown plug should be inserted is formed in the portion surrounded by the bottom plate portion 1a, the side plate portions 1b, the bridging portion 1c and the intermediate wall 1d.

A plurality of grooves 1f to which the first terminals 2 should be fitted are provided on the top of the intermediate wall 1d. In addition, protrusions 1g for preventing the first terminal block 3 from dropping off are provided on the opposite sides of the top of the intermediate wall 1d. In addition, a groove 1h to which the first terminal block 3 should be slide-fitted is provided in the inner surface of the upper portion of each side plate portion 1b. A plurality of recess portions 1i to which the front end portions of the first terminals 2 should be fitted fixedly are provided in the rear surface of the bridging portion 1c.

A recess portion 1j with which the second terminal block 5 should be linked is provided in the outer surface of each side plate portion 1b so as to extend forward from its rear end. A protrusion 1k for preventing the second terminal block 5 from dropping off is provided in each recess portion 1j. In addition, a link piece 1m for fixing the second terminal block 5 is provided in the rear portion of each side plate portion 1b so as to project rearward from the lower portion of the side plate portion lb. A groove 1n is provided in the surface opposite to each link piece 1m.

The bottom plate portion 1a has pins 1p for fixing the housing 1 to a not-shown motherboard.

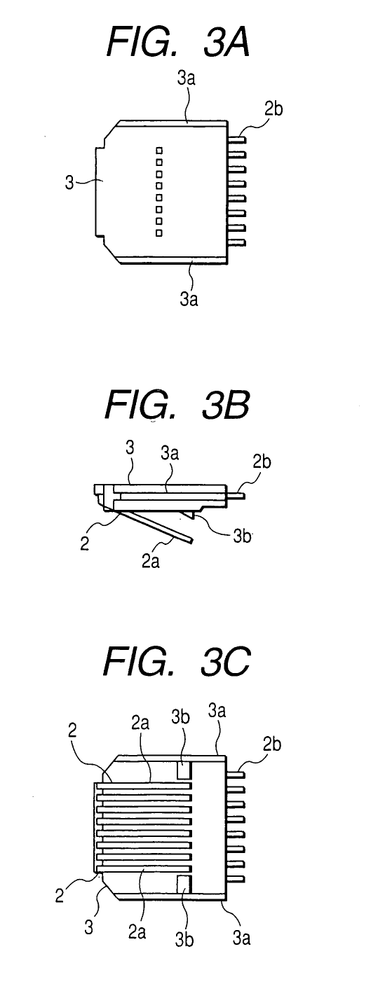

FIGS. 3A-3C show the first terminal block 3. FIG. 3A is a plan view; FIG. 3B, a side view; and FIG. 3C, a bottom view. The first terminal block 3 is made from resin, having intermediate portions of the first terminals 2 embedded integrally with the block 3. The first terminals 2 are to be brought into contact with terminals of a not-shown plug to be inserted into the internal space portion 1e of the housing 1, so as to be connected to the internal board 6. To this end, each first terminal 2 is bent rearward at the portion projecting from the front end of the first terminal block 3, so as to form a contact portion 2a to be in contact with its corresponding terminal of the plug. In addition, the rear portion of each first terminal 2 is made to project rearward from the rear end of the first terminal block 3, so as to form a connection portion 2b to be connected with the internal board 6. In addition, linear protrusions 3a for slide-fitting to the groove 1h of the housing 1 are provided on the opposite sides of the first terminal block 3. In addition, protrusions 3b to be locked in the protrusions 1g of the housing 1 are provided on the opposite sides of the lower surface of the first terminal block 3.

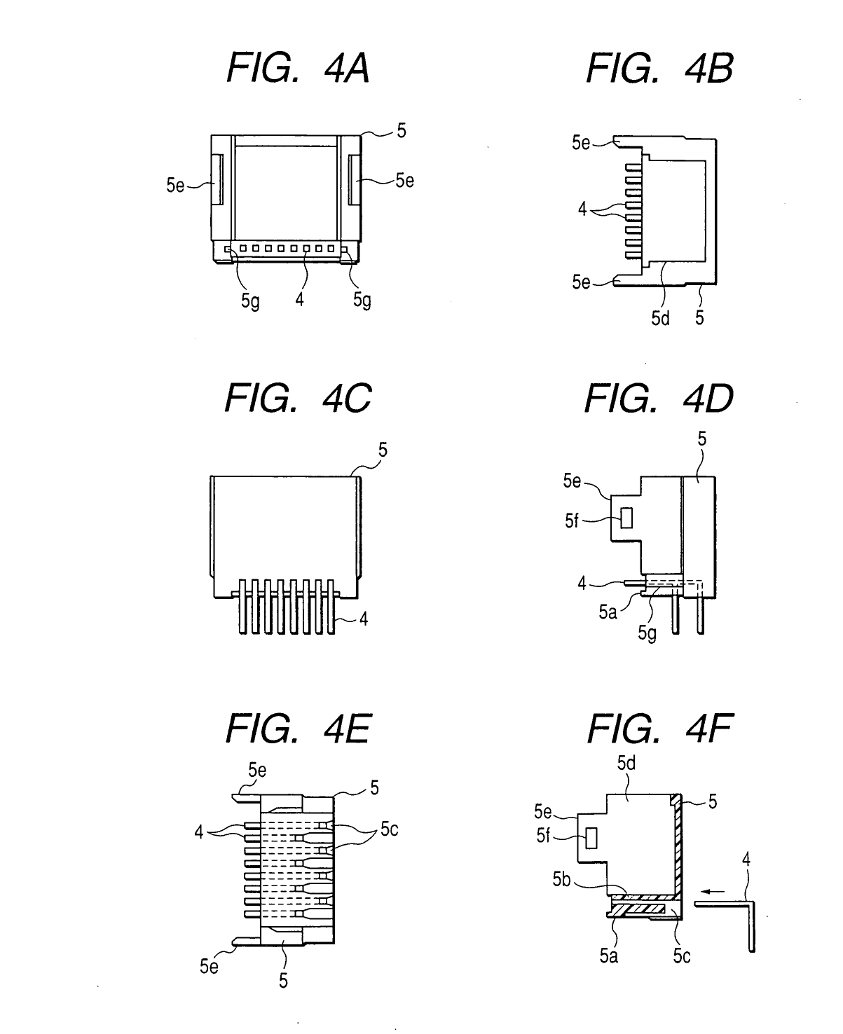

FIGS. 4A-4F show the second terminal block 5. FIG. 4A is a front view; FIG. 4B, a plan view; FIG. 4C, a back view; FIG. 4D, a side view; FIG. 4E, a bottom view; and FIG. 4F, a sectional view showing the structure in which a second terminal is assembled. The second terminal block 5 has a plurality of second terminals 4 incorporated in a bottom plate portion 5a. The second terminals 4 serve to establish connection between the internal board 6 and a not-shown motherboard. Each second terminal 4 has an L-shape. As shown in FIGS. 4E and 4F, a horizontal portion of the second terminal 4 is inserted into a hole 5b provided in the bottom plate portion 5a of the second terminal block 5 so as to extend in the front/rear direction, and a vertical portion of the second terminal 4 is fitted to the groove 5c. Thus, the second terminal 4 is fixed to the second terminal block S.

The second terminal block 5 has a box-like shape whose front is opened to receive electronic parts. In addition, an opening (5d) is also provided on the top of the second terminal block 5 so that the internal board 6 and the first terminals 2 can be soldered with each other through the opening (5d).

In the second terminal block 5, link pieces 5e for slide-fitting to the recess portions 1j provided in the outer surfaces of the side plate portions 1b of the housing 1 are formed to project forward from the opposite sides of the front of the second terminal block 5. In addition, holes 5f to be fitted to the protrusions 1k in the recess portions 1j in order to prevent the second terminal block 5 from dropping off are provided in the link pieces 5e respectively.

Linear protrusions 5g for slide-fitting to the grooves 1n of the link pieces 1m of the housing 1 are provided on the opposite sides of the bottom plate portion 5a.

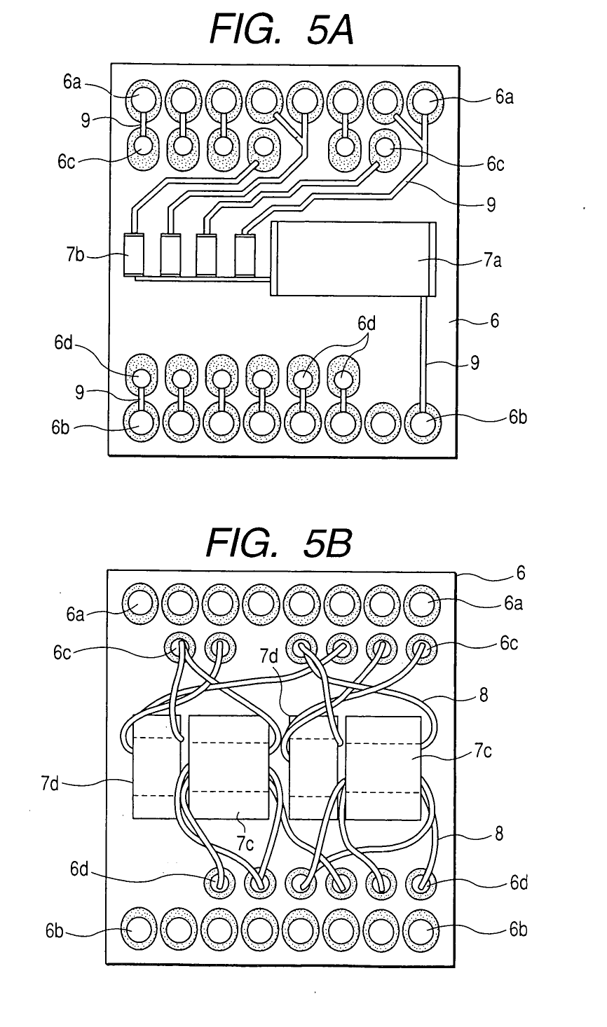

FIG. 5A shows the front surface of the internal board 6, and FIG. 5B shows the rear surface of the internal board 6. In the upper portion of the internal board 6, through-hole-like terminals 6a are arrayed, to which the connection portions 2b at the rear ends of the first terminals 2 should be inserted and soldered. In addition, in the lower portion of the internal board 6, through-hole-like terminals 6b are arrayed, to which the second terminals 4 should be inserted and soldered. In this embodiment, as the electronic parts to be mounted, a capacitor 7a and resistors 7b are mounted on the front surface of the internal board 6, and transformers 7c and common mode choke coils 7d are mounted on the rear surface of the internal board 6 so as to be as high as the mean height of the internal board 6.

An equivalent circuit diagram of the present embodiment is shown in FIG. 9.

The winding terminals 8 of the transformers 7c and the common mode choke coils 7d which are winding parts are inserted into the through holes 6c provided between these parts 7c and 7d and the through-hole-like terminals 6a in the upper portion or the through holes 6d provided between these electronic parts 7c and 7d and the through-hole-like terminals 6b in the lower portion, and soldered therein. As shown in FIG. 5A, a conductor pattern 9 establishes suitable connections between the electronic parts 7a and 7b or between the electronic parts 7a and 7b and the through-hole-like terminals 6a and 6b or the through holes 6c and 6d.

When this modular jack is assembled, the electronic parts 7a to 7d are fixed to the internal board 6 in advance by soldering. In this case, the terminals 8 of the transformers 7c and the common mode choke coils 7d which are winding parts can be soldered through the through holes 6c and 6d easily.

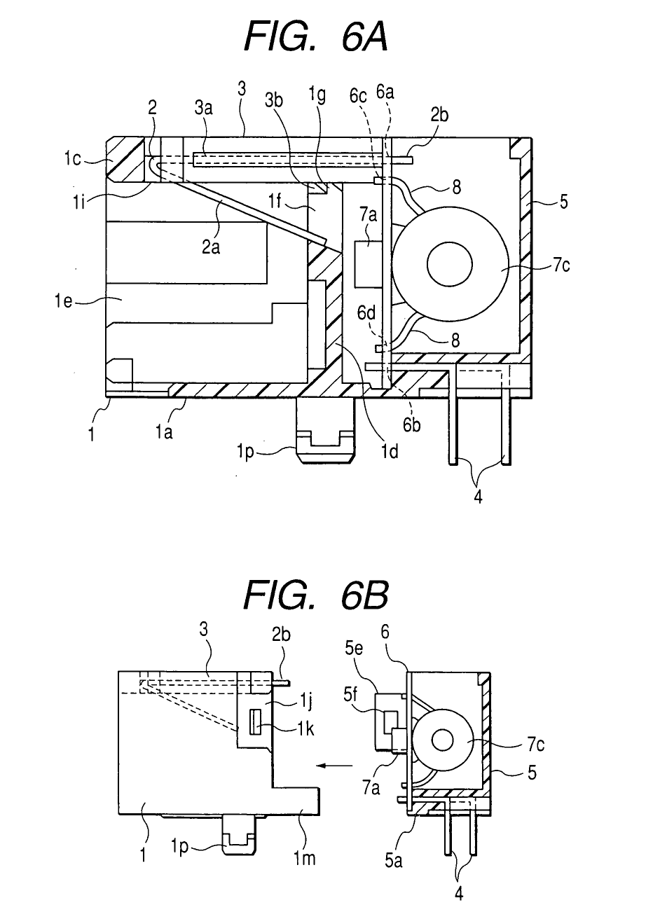

As for the first terminal block 3, the linear protrusions 3a on the opposite sides of the first terminal block 3 are slide-fitted into the grooves 1h of the housing 1, and the protrusions 3b on the lower surface of the first terminal block 3 are locked in the protrusions 1g of the housing 1 (see the sectional view of FIG. 6A). Thus, the first terminal block 3 is received fixedly in the top opening portion of the housing 1. FIG. 6B shows this state.

On the other hand, the terminals 4 of the second terminal block 5 are inserted into the through-hole-like terminals 6b arrayed in the lower portion of the internal board 6, and soldered therein in advance, as shown in FIG. 6B. Then, as soon as the second terminal block 5 is incorporated in the housing 1, the first terminals 2 are inserted into the through-hole-like terminals 6a arrayed in the upper portion of the internal board 6. At the same time, the link pieces 5e on the opposite sides of the second terminal block 5 are fitted into the recess portions 1j of the side plate portions 1b of the housing 1 so that the holes 5f of the link pieces 5e are fitted to the protrusions 1k. Thus, the second terminal block 5 fixed to the housing 1 is prevented from dropping off. At the same time, the linear protrusions 5g on the opposite sides of the bottom plate portion 5a of the second terminal block 5 are fitted into the grooves 1n of the link pieces 1m of the housing 1 so as to fix the bottom portion of the second terminal block 5 to the housing 1. After that, the first terminals 2 are soldered to the through-hole-like terminals 6a by means of a soldering iron or the like inserted from the top opening portion of the second terminal block 5.

Incidentally, the modular jack assembled thus is covered with a not-shown shielding metal cover. Excepting a front opening for receiving the connector plug and a bottom surface, all outer surfaces are covered by the metal cover.

In such a manner, the terminal block is divided into two blocks 3 and 5 on the plug terminal contact side and on the mother board connection side. As a result, in comparison with the case where the terminal block is integrated into one block, the degree of freedom in assembling structure is increased so that the modular jack can be miniaturized while assembling becomes easy.

In addition, since the through-hole-like terminals 6a and 6b making connection with the terminals 2 and 4 are provided in the internal board 6, the terminals 2 and 4 can be connected easily. Further, since the electronic parts 7a to 7d are not received into any block but mounted on the internal board 6, assembling becomes easy. In addition, in comparison with the case where the modular jack is mounted on a board, a connection device including the modular jack can be miniaturized.

In addition, since the electronic parts 7a to 7d are mounted on the internal board 6, and the first and second terminals 2 and 4 are soldered with the internal board 6, assembling becomes easy. In addition, the modular jack is not mounted on the board mounted with the electronic parts but arranged so that the terminal blocks 3 and 5 are linked with the housing 1 of the modular jack, and the internal board 6 is linked with the terminal blocks 3 and 5. Thus, the modular jack can be arranged in a small size.

When the electronic parts 7c and 7d are winding parts, the winding terminals 8 are inserted into the through holes 6c and 6d, and soldered therein in advance. Then, the terminals 2 and 4 are soldered with the internal board 6 in another process. Thus, not only the work of soldering the winding terminals 8 but also the work of soldering the terminals 2 and 4 to the internal board become easy.

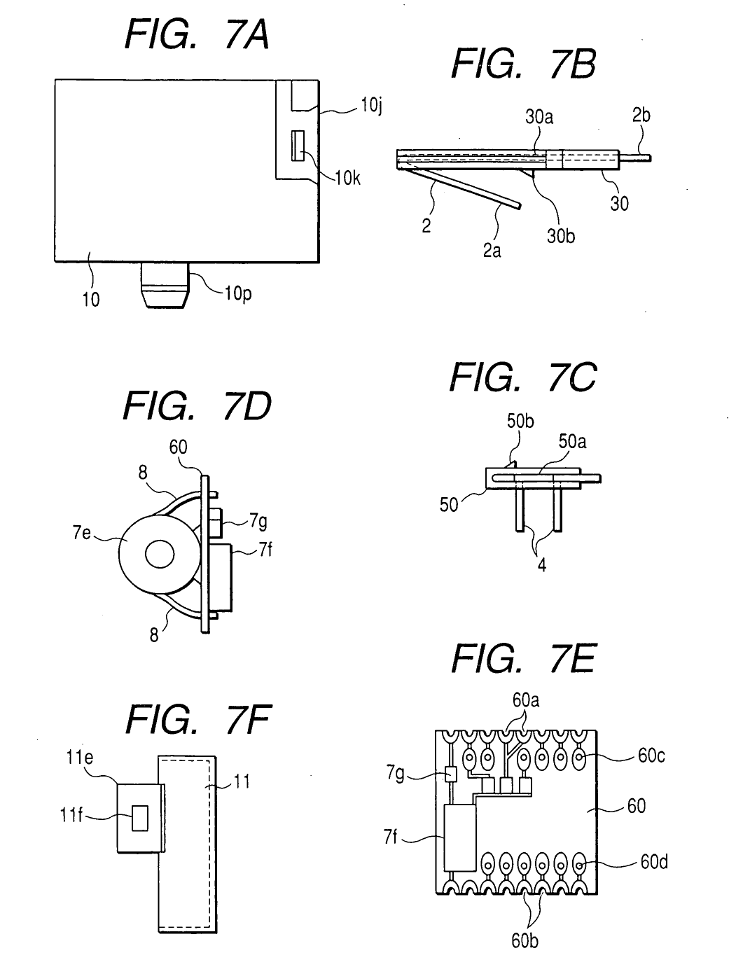

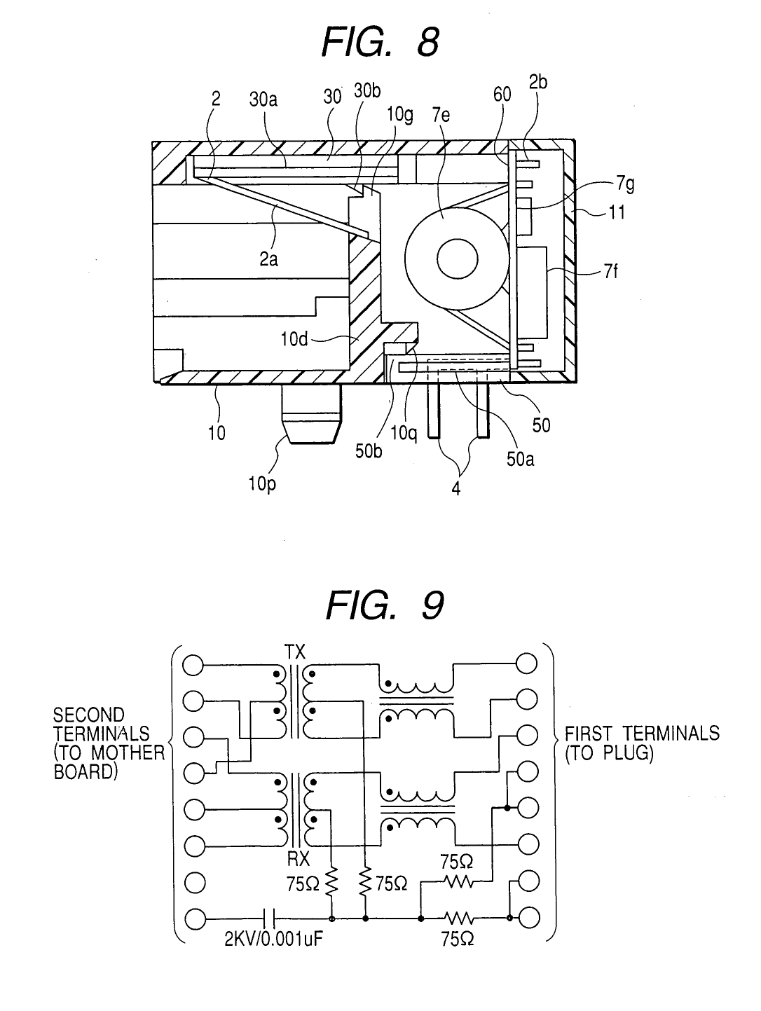

FIGS. 7A-7F are views showing constituent parts in another embodiment of the modular jack according to the present invention. FIG. 8 is a sectional view showing the state where the modular jack has been assembled. In this embodiment, a first terminal block 30 having first terminals 2 and a second terminal block 50 having second terminals 4 are incorporated in a housing 10. A link structure similar to that of the aforementioned embodiment can be adopted as the structure for linking the first terminal block 30 with the housing 10. That is, linear protrusions 30a provided on the opposite sides of the first terminal block 30 are slide-fitted into not-shown grooves provided in the inner surfaces of side plates of the housing 10, while protrusions 30b of the first block 30 are locked in protrusions 10g provided in the top portion of an intermediate wall 10d of the housing 10d so as to prevent the first terminal block 30 from dropping off.

On the other hand, the following structure is adopted as the structure for linking the second terminal block 50 with the housing 10. That is, protrusions 50a of the side surfaces of the second terminal block 50 are slide-fitted into not-shown grooves provided in the inner surfaces of side plate portions of the housing 10, while protrusions 50b of the second terminal block 50 are locked in protrusions 10q provided in the intermediate wall 10d of the housing 10d so as to prevent the second terminal block 50 from dropping off. The reference numeral 10p represents a pin for fixing the housing 10 to a mother board.

The reference numeral 60 represents an internal board. An electronic part 7e which is a winding part such as a transformer or a common mode choke coil, and electronic parts 7f and 7g such as capacitors or resistors are mounted on the internal board 60. Notch-like terminals 60a and 60b are provided in the upper and lower edges of the internal board 60. In addition, the internal board 60 has through holes 60c and 60d to which winding terminals 8 of the winding part should be inserted and soldered. The reference numeral 9 represents a conductor pattern for establishing suitable connections among the electronic parts 7e to 7g, the through holes 60c and 60d, and the terminals 60a and 60b.

The reference numeral 11 represents a cover having a structure whose front is open to be linked with a rear portion of the housing 10. A structure similar to the linking structure of the second terminal block 5 in the aforementioned embodiment can be adopted as the structure for linking the cover 11 with the housing 10. That is, link pieces 11e of the cover 11 are fitted into recess portions 10j of side surfaces of the housing 10, and holes 11f of the link pieces 11e are fitted to protrusions 10k of the recess portions 10j. Thus, the cover 11 is prevented from dropping off.

When the modular jack according to this embodiment is assembled, the first and second terminal blocks 30 and 50 are incorporated in the housing 10 in advance. Then, the internal board 60 mounted with the electronic parts 7e to 7g is mounted and soldered so that the first and second terminals 2 and 4 are fitted to the notch-like terminals 60a and 60b respectively. After that, the cover 11 is attached to the housing 10 from its rear so as to cover the internal board 60 therewith.

With such a structure, the work of soldering between the internal board 60 and the first terminals 2 and between the internal board 60 and the second terminals 4 can be carried out at one time. Thus, the assembling work can be performed efficiently.

When the invention is carried out, electronic parts to be mounted on the internal board may include electronic parts such as light emitting diodes if necessary. When light emitting diodes are mounted, only a circuit pattern thereof maybe provided on the internal board 6 or 60, while a body portion thereof is provided in the housing 1 or 10, or the like.

As has been described above, according to the invention, it is possible to provide a modular jack which is easy to assemble and which can be miniaturized.

What is claimed is:

1. A modular jack comprising:
a housing having an internal space into which a plug should be inserted;
a first terminal block incorporated in said housing and integrally provided with first terminals to be in contact with terminals of the plug, so that front portions of said first terminals are exposed to said internal space, while rear ends of said first terminals project at the rear of said first terminal block;
a second terminal block having second terminals to be connected with a motherboard to which the modular jack is attached; and
an internal board mounted with electronic parts and including through-hole-like or notch-like terminals to which said first and second terminals are soldered.

2. A modular jack according to claim 1, wherein said electronic parts include at least one of a common mode choke coil and a transformer.

3. A modular jack according to claim 1, wherein said electronic parts include at least one of a resistor, a capacitor and a light emitting diode.

4. A modular jack according to claim 1, wherein said electronic parts include a winding part; and
said internal board has through holes to which terminals of said winding parts are inserted and soldered.

5. A modular jack according to claim 1, wherein said second terminal block is incorporated on the back surface side of said housing, while said internal board is provided between said first terminal block and said second terminal block.

6. A modular jack according to claim 1, further comprising a metal cover covering outer surfaces of the modular jack.

7. A modular jack according to claim 1, wherein said first terminal block and said second terminal block are received and incorporated in said housing so that connection portions of said first and second terminals to said internal board project rearward;
said connection portions of said first and second terminals are inserted and soldered to said through-hole-like or notch-like terminals of said internal board; and
a cover covering said internal board therewith is provided on the back surface side of said housing.

8. A modular jack according to claim 1, wherein a plurality of through-hole-like or notch-like terminals to which said first terminals are inserted and soldered are arrayed in an upper portion of said internal board; and
a plurality of through-hole-like or notch-like terminals to which said second terminals are inserted and soldered are arrayed in a lower portion of said internal board.
